(19) United States
(12) Patent Application Publication
(10) Pub. No.: US 2019/0062048 A1
(43) Pub. Date: Feb. 28, 2019

(54) TRASH BAG HOLDER

(71) Applicant: Jesus M. Ortiz Torres, Temple, PA (US)

(72) Inventor: Jesus M. Ortiz Torres, Temple, PA (US)

(21) Appl. No.: 16/114,213

(22) Filed: Aug. 28, 2018

Related U.S. Application Data
(60) Provisional application No. 62/550,658, filed on Aug. 27, 2017.

(51) Int. Cl. B65F 1/14; B65B 67/12

(52) U.S. Cl. CPC B65F 1/1415; B65B 67/1233; B65B 67/1211

(57) ABSTRACT

A trash bag holder, including a bag to receive objects therein, and a bag holder, including a first body including an opening, a second body to receive the bag therein, such that the second body receives the first body therein to clamp the bag between the first body and the second body, a first door attached to a first top side portion of the first body via a first hinge, and a second door attached to a second top side portion of the first body opposite the first top side portion of the first body via a second hinge.

### CROSS REFERENCE TO RELATED APPLICATIONS

This application claims the benefit of U.S. Provisional Patent Application No. 62/550,658, filed Aug. 27, 2017 and entitled “TRASH BAG HOLDER,” the entire disclosure of which is incorporated herein by reference.

### BACKGROUND

### 1. Field

The present general inventive concept relates generally to an improved trash bag holder.

### 2. Description of the Related Art

People who drive in vehicles such as cars and trucks often have a need to dispose of trash while they are driving. Many people hang old shopping bags (e.g., plastic bags) from an armrest in order to create a makeshift trash receptacle. However, it is difficult, inconvenient, and dangerous for drivers to try to locate an opening of the shopping bags while they are driving. Furthermore, even if the driver successfully inserts the trash into the shopping bag, the shopping bag often gets twisted and tears due to movement of the vehicle, causing a mess when the trash fails out of the shopping bag.

Therefore, there is a need for a user-friendly waste container that allows disposable shopping bags to be utilized with ease and convenience while a driver is driving a vehicle,

There is also a need for a waste container that allows user to utilize bags of all shapes and sizes for disposing trash therein,

### SUMMARY

The present general inventive concept provides an improved waste container that allows users to insert various types of bags therein for easy and convenient disposal.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a trash bag holder, including a bag to receive objects therein, and a bag holder, including a first body including an opening, a second body to receive the bag therein, such that the second body receives the first body therein to clamp the bag between the first body and the second body, a first door attached to a first top side portion of the first body via a first hinge, and a second door attached to a second top side portion of the first body opposite the first top side portion of the first body via a second hinge.

The trash bag holder may further include a strap detachably connected to sides of the bag holder, to allow a user to hang the trash bag holder from an armrest in a vehicle.

The strap may be detachably connected to the first body.

The first door and the second door may rotatably pivot downward in a direction of an inside portion of the bag when the object is inserted into the bag through the first door and the second door.

The trash bag holder may further include a plurality of clips disposed on side portions of the first body to allow the first body to be clipped and attached to the second body when the bag is disposed between the first body and the second body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 is a view of a trash bag holder, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

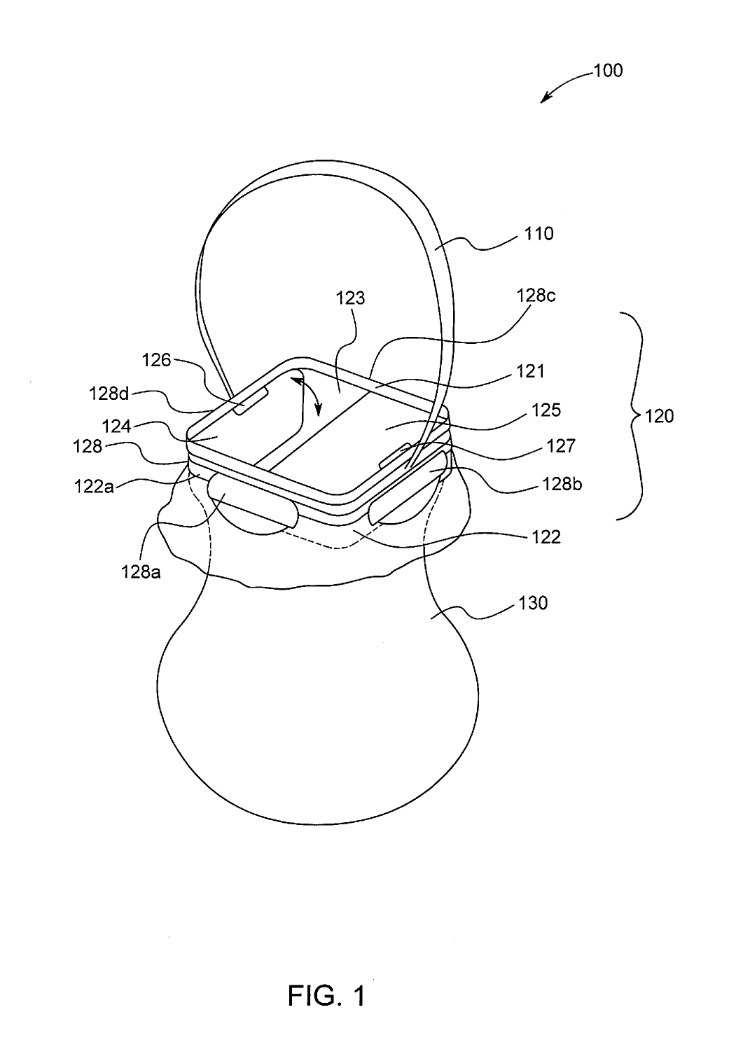

FIG. 1 is an angled view of a trash bag holder 100, according to an exemplary embodiment of the present general inventive concept.

Referring to FIG. 1, the trash bag holder 100 may be constructed from stainless steel, plastic, wood, paper, silicon, or any other material known to one of ordinary skill in the art.

The trash bag holder 100 may include a strap 110, a bag holder 120, and a bag 130.

The strap 110 may be constructed from fabric, plastic, or any other material known to one of ordinary skill in the art. The strap 110 may be detachably connected to sides of the bag holder 120, to allow a user to optionally hang the trash bag holder 100 from an armrest in a car or truck, for example. The strap 110 may be connected to two opposite sides the bag holder 120 using clips, pegs, snaps, VELCRO, or any other attachment devices known to one of ordinary skill in the art.

The bag holder 120 may include a first body 121, a second body 122, an opening 123, a first door 124, a second door 125, a first hinge 126, a second hinge 127, and a clip assembly 128.

As illustrated in FIG. 1, the strap 110 may be detachably connected to the first body 121.

The first body 121 may be inserted into the second body 122. The first body 121 and the second body 122 may optionally include magnets (not illustrated) at side portions thereof to allow for magnetic interconnection therebetween.

The clip assembly 128 may be connected to the first body 121. The clip assembly 128 may include clips 128a, 128b, 128c, and 128d, but may include less or more clips based on the user's preference.

The second body 122 may include a clip attaching portion 122a to allow the clips 128a, 128b, 128c, and 128d to be attached (e.g., clipped) thereto. As such, the clips 128a, 128b, 128c, and 128d allow the first body 121 to be secured to the second body 122, when the first body 121 is inserted within the second body 122.

The bag 130 may be made of any material such as plastic or paper, and may have any size desired by the user.

The bag 130 may be inserted into the second body 122 prior to the first body 121 being inserted into the second body 122, in order to allow the bag 130 to be firmly clamped between the first body 121 and the second body 122. After the bag 130 is inserted into the second body 122, followed by the first body 121 being inserted into the second body, the user may secure the clips 128a, 128b, 128c, and 128d to the clip attaching portion 122a of the second body 122, thereby securing portions of the bag 130 to the attaching portion 122a.

When the bag 130 is secured between the first body 121 and the second body 122, the user may insert objects (e.g., trash) through the opening 123, such that the objects are received by the bag 130 to be stored therein.

The first door 124 may be attached to a top side portion of the first body 121 using the first hinge 126, and the second door 125 may be attached to another top side portion (e.g., opposing side) of the first body 121 using the second hinge 127. The first hinge 126 and the second hinge 127 may include a spring (not illustrated) to allow the first door and the second door 125 to remain in a closed position until the user pushed through the doors to place an object through the opening 123. In other words, the first door 124 and the second door 125 close the opening 123, and maintain the closure of the opening 123, using a spring-mechanism of the hinges. After the user pushes the first door 124 and the second door 125 open to insert the object through the opening 123 such that the object is received by the bag 130, the first door 124 and the second door 125 close upon a removal of a hand of the user from the opening 123.

FIG. 1 illustrated the first door 124 in an open position, and the second door 125 in a closed position, for illustrative purposes.

When the bag 130 is filled to capacity, the user may unclip the clips 128a, 128b, 128c, and 128d from the clip attaching portion 122a of the second body 122. Then, the user may remove the first body 121 from the second body 122, thereby allowing the user to remove the bag 123 from the second body 122.

The bag holder 120 may further include motion sensors (e.g., proximity sensors) and a trash compacting unit (not illustrated), in order to allow trash within the bag 130 to be compacted when the motion sensors detect that the bag 130 is almost filled to capacity.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A trash bag holder, comprising:
a bag to receive objects therein; and
a bag holder, comprising:
a first body including an opening,
a second body to receive the bag therein, such that the second body receives the first body therein to clamp the bag between the first body and the second body,
a first door attached to a first top side portion of the first body via a first hinge, and
a second door attached to a second top side portion of the first body opposite the first top side portion of the first body via a second hinge.

2. The trash bag holder of claim 1, further comprising:
a strap detachably connected to sides of the bag holder, to allow a user to hang the trash bag holder from an armrest in a vehicle.

3. The trash bag holder of claim 2, wherein the strap is detachably connected to the first body.

4. The trash bag holder of claim 1, wherein the first door and the second door rotatably pivot downward in a direction of an inside portion of the bag when the object is inserted into the bag through the first door and the second door.

5. The trash bag holder of claim 1, further comprising:
a plurality of clips disposed on side portions of the first body to allow the first body to be clipped and attached to the second body when the bag is disposed between the first body and the second body.
